(19) United States
(12) Patent Application Publication
(10) Pub. No.: US 2019/0389225 A1
(43) Pub. Date: Dec. 26, 2019

(54) Ink-Jet Recording Device and Ink Transport Method

(71) Applicant: Konica Minolta, Inc., Tokyo (JP)

(72) Inventor: Takeshi YAMAZAKI, Tokyo (JP)

(73) Assignee: Konica Minolta, Inc., Tokyo (JP)

(21) Appl. No.: 16/398,042

(22) Filed: Apr. 29, 2019

(30) Foreign Application Priority Data
Jun. 26, 2018 (JP) 2018-121062

(51) Int. Cl. B41J 2/19; B41J 2/175; B41J 2/185; B41J 2/17

(52) U.S. Cl. CPC B41J 2/19; B41J 2/17596; B41J 2002/1735; B41J 2/1721; B41J 2/185

(57) ABSTRACT

An ink-jet recording device which prevents bubbles generated in ink due to replacement of a component such as a recording head from entering a tank. The ink-jet recording device includes: a tank which stores ink; a recording head to which the ink in the tank is supplied; a supply flow path for allowing the ink in the tank to flow to the recording head; a collection flow path for returning the ink discharged from the recording head to the tank; and a degassing module which is located downstream of the recording head and upstream of the tank in the collection flow path and when a condition to perform a degassing process to remove bubbles contained in the ink discharged from the recording head is satisfied, performs the degassing process.

### CROSS-REFERENCE TO RELATED APPLICATIONS

The entire disclosure of Japanese Patent Application No. 2018-121062, filed on Jun. 26, 2018, is incorporated herein by reference in its entirety.

### BACKGROUND

### Technological Field

The present invention relates to an ink-jet recording device and an ink transport method.

### Description of the Related Art

In the related art, an ink-jet recording device which makes an image by discharging ink from a recording head (ink-jet head) onto a recording material can make a high-precision image using a compact recording head with a plurality of nozzles arranged densely. Furthermore, by arranging a plurality of recording heads and supplying different color inks to the heads, a color image can be obtained at low cost by a compact structure. Or, recording can be made on a wide large recording material by recording heads arranged almost in a row. As mentioned above, ink-jet recording devices offer many advantages.

In ink-jet recording devices as mentioned above, it is important to ensure that ink discharge from a recording head is stable. For example, in some ink-jet recording devices, ink is circulated in the recording head to prevent ink sedimentation and recover a missing nozzle automatically. Usually, a certain amount of gas is dissolved in ink. If the gas (dissolved gas) turns into bubbles in the ink flow path or recording head, it may generate such adverse effects that the bubbles hamper the flow of the ink or ink clogging or a phenomenon that ink cannot be discharged from a nozzle occurs. For this reason, as a countermeasure against this problem, a deaerator to degas the ink supplied to the recording head is provided or the ink to be used is degassed in advance and packaged for use. However, in the deaerator, bubbles and dissolved gas are removed from the ink and at the same time a small amount of moisture evaporates, resulting in an increase in ink viscosity.

Patent Literature 1 (JP-A-2010-83021) discloses an ink-jet recording device which circulates ink from a supply sub tank through an ink-jet head into a collection sub tank in order to suppress ink discharge failures due to increased ink viscosity. In this ink-jet recording device, a bypass flow path connecting the sub tanks is provided as a circulation passage to circulate the ink in the supply sub tank without allowing the ink to pass through the ink-jet head and a deaerator is also provided midway in the circulation passage and just before the supply sub tank. According to the internal pressure of each sub tank, the ink is transported between the supply sub tank, collection sub tank and buffer tank so that pressure control is performed to keep the internal pressure of each sub tank at a target pressure level.

### CITATION LIST

### Patent Literature

Patent Literature 1: JP-A-2010-83021

### SUMMARY

Generally, during replacement of a recording head, a lot of bubbles (air) are generated in the ink in the circulation passage. In the technique described in Patent Literature 1, if these bubbles get into the circulation passage, a lot of bubbles may adhere to the inner wall of the collection sub tank or buffer tank. If the bubbles adhering to the inner wall get mixed in the ink again, they will be transported to the recording head through the circulation passage, which may cause an adverse effect as mentioned above. Therefore, it is necessary to remove the bubbles adhering to the inner wall of the tank. However, it takes a long time until the bubbles adhering to the inner wall are completely removed (the bubbles are peeled off from the wall and removed).

With the above background, a technique which prevents bubbles generated in ink due to replacement of a component such as a recording head from entering a tank has been demanded.

To achieve the abovementioned object, according to an aspect of the present invention, an ink-jet recording device reflecting one aspect of the present invention comprises: a tank which stores ink; a recording head to which the ink in the tank is supplied; a supply flow path for allowing the ink in the tank to flow to the recording head: a collection flow path for returning the ink discharged from the recording head to the tank; and a degassing module which is located downstream of the recording head and upstream of the tank in the collection flow path and when a condition to perform a degassing process to remove bubbles contained in the ink discharged from the recording head is satisfied, performs the degassing process.

### BRIEF DESCRIPTION OF THE DRAWINGS

The advantages and features provided by embodiments of the invention will become more fully understood from the detailed description given hereinbelow and the appended drawings which are given by way of illustration only, and thus are not intended as a definition of the limits of the present invention:

FIG. 1 is an explanatory diagram which shows an example of the configuration of the ink supply system of an ink-jet recording device according to a first embodiment of the present invention;

FIG. 2 is a block diagram which shows an example of the configuration of the main part of the control system of the ink-jet recording device according to the first embodiment of the present invention;

FIG. 3 is a flowchart which shows an example of the component replacement sequence according to the first embodiment of the present invention:

FIG. 4 is an explanatory diagram which shows an example of the configuration of the ink supply system of an ink-jet recording device according to a second embodiment of the present invention;

FIG. 5 is a block diagram which shows an example of the configuration of the main part of the control system of the ink-jet recording device according to the second embodiment of the present invention; and

FIG. 6 is a flowchart which shows an example of the component replacement sequence according to the second embodiment of the present invention.

### DETAILED DESCRIPTION OF EMBODIMENTS

Hereinafter, embodiments of the present invention will be described with reference to the drawings.

However, the scope of the invention is not limited to the disclosed embodiments. In the specification and the appended drawings, the constituent elements which have substantially the same functions or structures are designated by the same reference signs and repeated description thereof is omitted.

### 1. First Embodiment

### [Ink Supply System of the Ink-Jet Recording Device]

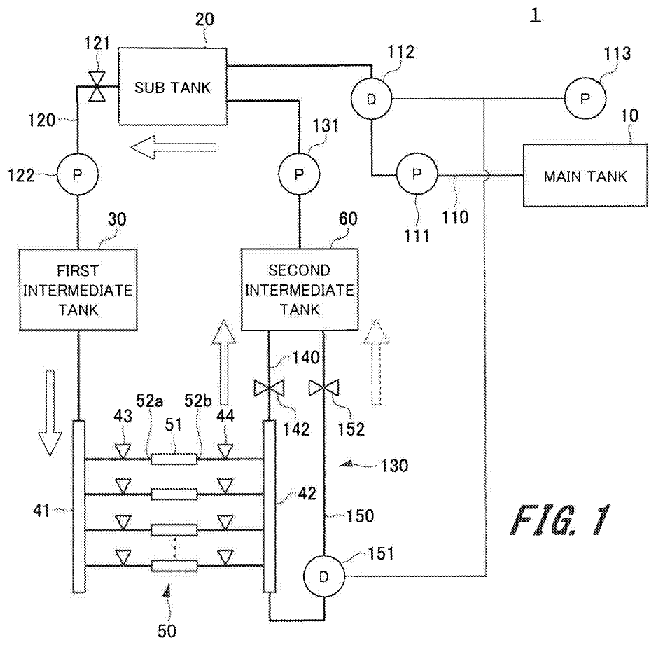

First, the ink supply system of the ink-jet recording device according to the first embodiment of the present invention will be described. FIG. 1 shows an example of the configuration of the ink supply system of ink-jet recording device according to the first embodiment. For example, the ink-jet recording device 1 includes an ink supply system for each of yellow (Y), magenta (M), cyan (C), and black (K) colors. FIG. 1 shows an ink supply system for one of the colors.

As shown in FIG. 1, the ink-jet recording device 1 includes a main tank 10, a sub tank 20, a first intermediate tank 30, a head unit 50, and a second intermediate tank 60. The main tank 10 is an airtight container for containing the ink to be supplied to the head unit 50.

The sub tank 20 (an example of an ink supply tank) is an airtight container for storing the ink contained in the main tank 10 as appropriate. The main tank 10 and the sub tank 20 are connected through a flow path 110 (an example of a replenishment flow path). A liquid transport pump 111 is provided midway in the flow path 110. The liquid transport pump 111 transports the ink discharged from the main tank 10 through the flow path 110 to the sub tank 20 (replenishment). Also, a degassing module 112 is provided midway in the flow path 110. The degassing module 112 performs the degassing process to remove bubbles and dissolved gas from the ink transported from the main tank 10 to the sub tank 20.

The sub tank 20 and the head unit 50 are connected through a flow path 120 (an example of a supply flow path). In the flow path 120, a supply electromagnetic valve 121, a liquid transport pump 122 and the first intermediate tank 30 are arranged in order from upstream. The liquid transport pump 122 transports the ink discharged from the sub tank 20 through the flow path 120 to the first intermediate tank 30. When the supply electromagnetic valve 121 is in the open state, a liquid transport pump 122 located on the flow path 120 transports the ink in the sub tank 20 through the flow path 120 to the first intermediate tank 30.

The first intermediate tank 30 is connected to the supply side manifold 41 of the head unit 50 through the flow path 120. The first intermediate tank 30 is an airtight container which stores the ink discharged from the sub tank 20 as appropriate.

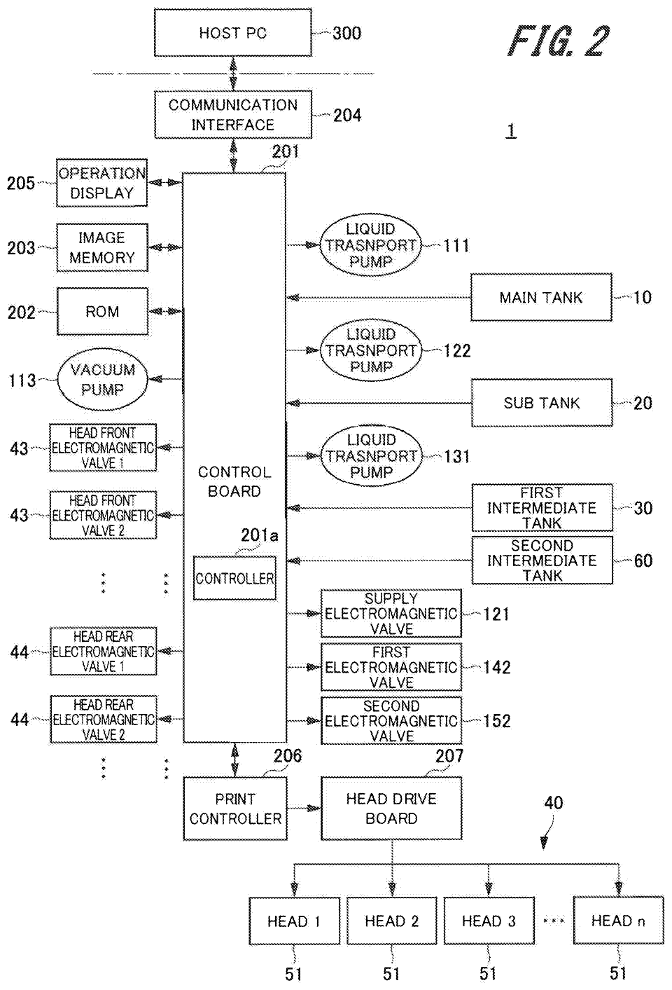

The head unit 50 includes a plurality of recording heads 51 (head 1 to head n in FIG. 2), a supply side manifold 41 (supply side collective pipe), and a collection side manifold 42 (collection side collective pipe). The supply side (supply port) of each recording head 51 is connected to a unit inside flow path (for example, a tube) by a coupling 52a and the collection side (discharge port) of each recording head 51 is connected to a unit inside flow path (for example, a tube) by a coupling 52b. A head front electromagnetic valve 43 (head front electromagnetic valves 1, 2 and so on in FIG. 2) is provided midway in each unit inside flow path which connects the supply side manifold 41 and the coupling 52a for each recording head 51.

Also, a head rear electromagnetic valve 44 (head rear electromagnetic valves 1, 2 and so on in FIG. 2) is provided midway in each unit inside flow path which connects the coupling 52b for each recording head 51 and the collection side manifold 42. The head rear electromagnetic valve 44 is an example of an on-off valve. The unit inside flow path which connects the coupling 52b and the collection side manifold 42 may be considered as part of the collection flow path. Specifically, the head rear electromagnetic valve 44 is located downstream of the recording head 51 and upstream of the branching point between a first passage 140 and a second passage 150 (the collection side manifold 42 in FIG. 1) in the collection flow path.

The head unit 50 and the sub tank 20 are connected through a flow path 130 (an example of a collection flow path). In the flow path 130, the second intermediate tank 60 and a liquid transport pump 131 are arranged in order from upstream. The sub tank 20, flow path 120, head unit 50, and flow path 130 constitute a circulation passage.

A portion of the flow path 130 (specifically, between the head unit 50 and the second intermediate tank 60) is structured in a manner to be bifurcated into the first passage 140 and the second passage 150. The collection side manifold 42 has two ink discharge ports. The first discharge port of the collection side manifold 42 is connected to the second intermediate tank 60 through the first passage 140. The second discharge port of the collection side manifold 42 is connected to the second intermediate tank 60 through the second passage 150.

A first electromagnetic valve 142 (an example of a first on-off valve) is provided midway in the first passage 140. In the second passage 150, a degassing module 151 and a second electromagnetic valve 152 (an example of a second on-off valve) are arranged in order from upstream. The first passage 140 and the second passage 150 are switched by controlling opening/closing of the first electromagnetic valve 142 and second electromagnetic valve 152.

In a non-degassing mode which will be described later, the first passage 140 brings the ink discharged from the head unit 50 (each recording head 51) into the second intermediate tank 60 without allowing the ink to pass through the degassing module 151. In a degassing mode which will be described later, the second passage 150 brings the ink discharged from the head unit 50 (each recording head 5) through the degassing module 151 into the second intermediate tank 60. The non-degassing mode and degassing mode as the modes of the flow path 130 (passages in which ink flows) are switched by a controller 201a (see FIG. 2) according to whether the condition to perform a degassing process is satisfied or not.

The second intermediate tank 60 is connected to the collection side manifold 42 of the head unit 50 through the flow path 130. The second intermediate tank 60 is an airtight container for storing the ink which is discharged from the head unit 50 (each recording head 51) and returned to the sub tank 20 as appropriate. The liquid transport pump 131 transports the ink discharged from the second intermediate tank 60 to the sub tank 20 through the flow path 130.

The first intermediate tank 30 and the second intermediate tank 60 may be realized in various ways in terms of structure and operation. For example, the first intermediate tank 30 and the second intermediate tank 60 may each include a pressure sensor (not shown) for measuring the internal pressure of the liquid chamber for storing ink so that the controller 201a controls operation of the liquid transport pumps 122 and 131 according to the result of measurement (for example, pressure difference) by the pressure sensor of each intermediate tank to adjust the amount of ink supplied to the head unit 50. Or, the first intermediate tank 30 and the second intermediate tank 60 may each include a flow sensor (not shown) for detecting the liquid surface (liquid level) of ink so that the controller 201a controls operation of the liquid transport pumps 122 and 131 according to the result of detection by the flow sensor of each intermediate tank to adjust the amount of ink supplied to the head unit 50.

The degassing module 151 performs the degassing process to remove bubbles and dissolved gas from the ink transported from the head unit 50 to the second intermediate tank 60. The degassing modules 112 and 151 collect the bubbles generated in the ink and dissolved gas through a permeable membrane by operation of a common vacuum pump 113. Since the structure of the degassing modules and the principle of degassing are publicly known, detailed description thereof is omitted.

### [Control System of the Ink-Jet Recording Device]

Next, the main part of the control system of the ink-jet recording device 1 will be described. FIG. 2 is a block diagram which shows an example of the configuration of the main part of the control system of the ink-jet recording device 1.

The ink-jet recording device 1 includes a communication interface 204, a control board 201, a ROM 202, an image memory 203, an operation display 205, a print controller 206, a head drive board 207 and so on.

The communication interface 204 is an interface for receiving a print job including image data which is sent from a host PC (Personal Computer) 300. The communication interface 204 may be a serial interface such as a USB (Universal Serial Bus), IEEE 1394, Ethernet (registered trademark) or wireless network, or a parallel interface such as Centronics interface. A buffer memory (not shown) may be mounted in this part in order to increase the communication speed. The image data sent from the host PC 300 is loaded in the ink-jet recording device 1 through the communication interface 204 and once stored in the image memory 203.

The image memory 203 is a storage which once stores the image data received through the communication interface 204 and data is read from or written to the image memory 203 through the control board 201 (controller 201a). The image memory 203 is not limited to a memory as a semiconductor device, but it may be a magnetic medium such as a hard disk.

The controller 201a, peripheral circuits (not shown) and so on are mounted on the control board 201. The controller 201a includes an arithmetic processing unit such as a CPU (Central Processing Unit) or an MPU (Micro-Processing Unit). The controller 201a controls various components including the communication interface 204, image memory 203, and print controller 206. The controller 201a controls communications with the host PC 300 and controls reading/writing with the image memory 203 and also generates control signals to control the liquid transport pumps 111, 122, and 131, vacuum pump 113, supply electromagnetic valve 121, first electromagnetic valve 142, second electromagnetic valve 152, a plurality of head front electromagnetic valves 43 and a plurality of head rear electromagnetic valves 44.

The controller 201a controls the drive of the liquid transport pumps 122 and 131, for example, according to the result of detection by each pressure sensor of each intermediate tank (internal pressure of each intermediate tank) to move the ink between the first intermediate tank 30, the second intermediate tank 60, and the sub tank 20 so that the internal pressure of each tank is kept at a target pressure level.

The ROM (Read Only Memory) 202 stores the program to be executed by the controller 201a of the control board 201, various data required for control and so on. Although in the present embodiment a ROM 202 (non-rewritable) is used as the memory to store various data such as the program and operation parameters, instead a rewritable storage such as EEPROM or a hard disk may be used. The ink-jet recording device 1 includes a RAM (not shown) which is used as a temporary memory area for image data and also used as a program decompression area and a CPU arithmetic processing work area.

The program stored in the ROM 202 is read and executed according to a command from the controller 201a. Also, an external interface may be provided and a memory card or a PC card may be used as an external memory. Obviously, among these recording media, two or more recording media may be provided.

The operation display 205 has a structure in which a display part such as a liquid crystal display panel and an operation part such as a touch panel are stacked. The display part displays a GUI screen or the result of processing performed by the controller 201a. The user can operate the operation part in a given manner to enter a command. The controller 201a performs processing according to an input signal from the operation part.

The ink-jet recording device 1 has a pump driver (not shown) to drive each pump. The pump drivers are drivers which drive the liquid transport pumps 11, 122, and 131 in the ink supply system and the vacuum pump 113 according to a command from the controller 201a.

Furthermore, the controller 201a supplies control signals for the supply electromagnetic valve 121, the head front electromagnetic valve 43 and head rear electromagnetic valve 44 provided on each of the recording heads 51 (head 1 to head n) and the first electromagnetic valve and second electromagnetic valve provided in the flow path 130.

The control board 201 includes a digital-analog conversion circuit (not shown) which converts the analog detection signals sent from the pressure sensors or flow sensors (not shown) provided in the main tank 10, sub tank 20, first intermediate tank 30 and second intermediate tank 60 into digital data. The controller 201a controls operation of the pumps, electromagnetic valves and so on according to digital data sent from the digital-analog conversion circuit.

The print controller 206 has the signal processing function to perform various processes to generate a printing control signal from image data in the image memory 203 and processing for correction, according to control by the control board 201, and supplies the generated printing control signal (dot data) to the head drive board 207. Signal processing as required is performed in the print controller 206 and according to the image data, the ink droplet discharge rate and discharge timing of the recording head 51 of the head unit 50 are controlled through the head drive board 207. Consequently, the desired dot size and dot arrangement can be achieved.

An image buffer memory may be provided as a memory attached to the print controller 206. In this case, during image data processing in the print controller 206, data such as image data and parameters are temporarily stored in the image buffer memory. Alternatively, the print controller 206 and the controller 201a of the control board 201 may be integrated into one processor.

The head drive board 207 generates a drive signal to drive the piezoelectric element (not shown) of a recording head 51 for each color according to dot data given by the print controller 206 and supplies the generated drive signal to the piezoelectric element. The head drive board 207 may include a feedback control system to keep the driving condition for the several recording heads 51 in the head unit 50 constant.

The ink-jet recording device 1 may include a printing detector (not shown). The printing detector is a block which includes, for example, a line sensor. The printing detector reads the image printed on recording paper and detects the printing condition (discharge or non-discharge of ink, droplet ejection fluctuations, etc.) by performing signal processing as required, and supplies the result of detection to the print controller 206. The print controller 206 makes various corrections for the recording heads 51 according to information obtained from the printing detector as necessary. In addition, if the print controller 206 determines that it is necessary to replace a component such as a recording head 51, it causes the operation display 205 to display a message urging replacement of the component. For example, the controller 201a specifies and indicates the recording head 51 to be replaced and reads the positions of the head front electromagnetic valve 43 and head rear electromagnetic valve 44 relating to that recording head 51 from the ROM 202.

### [Component Replacement Sequence]

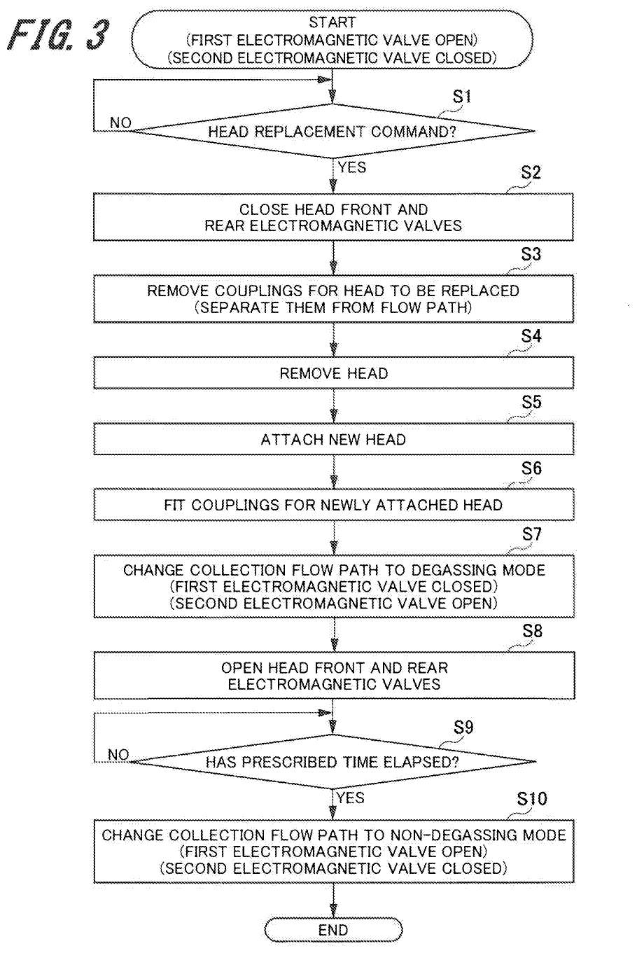

Next, an example of the component replacement sequence for the ink-jet recording device 1 will be explained. FIG. 3 is a flowchart which shows an example of the component replacement sequence. The component replacement sequence shown in FIG. 3 includes the steps to be carried out by a worker.

It is assumed here that in the non-degassing mode in which ink is not degassed, the controller 201a performs control so that the first electromagnetic valve 142 (see FIG. 1) in the first passage 140 of the flow path 130 is kept open and the second electromagnetic valve 152 in the second passage 150 is kept closed. Examples of the non-degassing mode are a waiting mode and a printing mode. Also, the vacuum pump 113 connected to the degassing module 112 and the degassing module 151 is assumed to be operated constantly. In many cases, generally the ink brought into the sub tank is constantly degassed by the degassing module 112 in the flow path running from the main tank to the sub tank.

First, the controller 201a determines whether or not a head replacement command has been entered in the operation display 205 (S1) and if a head replacement command has not been entered (NO at S1), this determination step is repeated.

On the other hand, if a head replacement command has been entered (YES at S1), the controller 201a performs control to stop operation of various parts related to ink supply (for example, liquid transport pumps) and close the head front electromagnetic valve 43 and head rear electromagnetic valve 44 relating to the recording head 51 to be replaced (S2). This prevents leakage of a large amount of ink from the unit inside flow path during replacement of the recording head 51.

If a head replacement command has been entered, the controller 201a should cause the operation display 205 to show a message saying, for example, “Under preparation for head replacement” or “Please wait”. When preparations for replacement of the head of the ink-jet recording device 1 are completed, the controller 201a should cause the operation display 205 to show a message saying “Preparations for ink replacement are completed. Please remove the head” or the like.

Next, the worker removes the couplings 52a and 52b for the recording head 51 to be replaced, among the recording heads 51 of the head unit 50, and separates the recording head 51 from the unit inside flow path (S3). Then, the worker removes the recording head 51 from the head unit 50 (S4). Then, the worker attaches a new recording head 51 to the head unit 50 (S5) and fits the couplings 52a and 52b for the newly attached recording head 51 and connects the recording head 51 to the unit inside flow path (S6). The recording head replacement may generate a large amount of bubbles in the ink in the flow path.

For example, in order to detect completion of head replacement by the worker, the controller 201a may cause the operation display 205 to show the “HEAD REPLACEMENT COMPLETED” button (icon) so that, when it is detected that the “HEAD REPLACEMENT COMPLETED” button has been touched, the controller 201a determines that head replacement is completed. Or, when attachment of the recording head 51 or fitting of the couplings 52a and 52b is completed, these components may be detected by a mechanical switch, optical sensor or the like so that the controller 201a can determine that head replacement is completed.

Upon detecting completion of replacement of the recording head 51 (an example of the condition to perform the degassing process), the controller 201a changes the mode of the flow path 130 from the non-degassing mode to the degassing mode in order to degas the ink. Specifically, the controller 201a switches the ink flow path (the first passage 140 and second passage 150) by setting the first electromagnetic valve 142 in the first passage 140 of the flow path 130 to the closed state and setting the second electromagnetic valve 152 in the second passage 150 to the open state (S7).

Consequently, the mode of the flow path 130 is changed to the degassing mode and the ink discharged from the recording head 51 is brought into the second intermediate tank 60 through the second passage 150 of the flow path 130. The ink transported in the second passage 150 is degassed by the degassing module 151.

Next, the controller 201a performs control to open the head front electromagnetic valve 43 and head rear electromagnetic valve 44 which are in the closed state (S8). Then, the controller 201a determines whether or not a prescribed time has elapsed since the head front electromagnetic valve 43 and head rear electromagnetic valve 44 have been opened (S9), and if the prescribed time has not elapsed (NO at S9), this determination step is repeated. The prescribed time should be not less than the time required to prevent the bubbles contained in the ink discharged from the newly attached recording head 51 from entering the second intermediate tank.

On the other hand, if the prescribed time has elapsed (YES at S9), the controller 201a returns the mode of the flow path 130 to the non-degassing mode (S10). Specifically, the controller 201a sets the first electromagnetic valve 142 in the first passage 140 to the open state and sets the second electromagnetic valve 152 in the second passage 150 to the closed state. Since the ink is thus transported through the second passage 150 provided with the degassing module 151 until the elapse of the prescribed time, the ink discharged from the newly attached recording head 51 is degassed for an adequate time period, thereby preventing bubbles from entering the second intermediate tank 60.

Next, the controller 201a activates various parts related to ink supply (for example, liquid transport pumps) according to the demand of the head unit 50 for ink. The controller 201a ends the sequence shown in the flowchart of FIG. 3 after the process of Step S10 is ended.

Alternatively, the process of Step S8 to open the head front electromagnetic valve 43 and head rear electromagnetic valve 44 may be carried out after attachment of the couplings 52a and 52b for the recording head 5 (between Step S6 and Step S7). In this case, after the process to open the head front electromagnetic valve 43 and head rear electromagnetic valve 44 is carried out, the process to change the collection flow path to the degassing mode is carried out before the bubbles contained in the ink discharged from the recording head 51 reach the second intermediate tank 60. Or, the process to open the head front electromagnetic valve 43 and head rear electromagnetic valve 44 and the process to change the collection flow path to the degassing mode may be carried out simultaneously or substantially simultaneously.

The abovementioned sequence is a sequence for the ink supply system for one ink color and if the recording head 51 for another ink color in the head unit 50 is also to be replaced, the worker should replace the recording head 51 concerned using the same procedure.

According to the above first embodiment, when a recording head 51 is replaced, the controller 201a changes the mode of the flow path 130 (collection flow path) to the degassing mode so that the ink discharged from the recording head 51 is brought into the second intermediate tank 60 through the second passage 150 of the flow path 130. Consequently, the ink discharged from the recording head 51 and brought into the second intermediate tank 60 is degassed by the degassing module 151 to prevent bubbles from entering the second intermediate tank 60. Thus, the first embodiment can prevent the bubbles generated in ink due to replacement of a component such as a recording head (for example, a recording head 51) from entering a tank (for example, the second intermediate tank 60).

In the technique described in Patent Literature 1, the deaerator is located in the passage for supplying ink to the head (just before the supply sub tank) and the ink is degassed constantly, so it may be considered that deterioration of ink (increase in viscosity) easily occurs. By contrast, in the first embodiment, in order to degas the ink, the mode of the flow path 130 is changed to the degassing mode and the ink discharged from the recording head 51 is degassed by the degassing module 151 in the second passage 150, so degassing is done only when necessary. Consequently, the ink degassing time can be minimized and the deterioration of ink (increase in viscosity) can be suppressed.

Furthermore, in the first embodiment, as for a plurality of recording heads 51 arranged in the head unit 50, each recording head 51 can be replaced individually, so the object of degassing is the ink in the flow path connected to the recording head 51 to be replaced. Since each recording head 51 can be replaced individually, the amount of bubbles mixed in the ink can be minimized as compared with the case that all the recording heads 51 are replaced at a time. Therefore, the time required for degassing after replacement can be shortened. In addition, since the degassing time is shortened, power consumption of the vacuum pump 113 can be reduced.

In the above description of the first embodiment, the vacuum pump 113 is assumed to be operated constantly; however, the vacuum pump 113 may be assumed to be operated only when the ink transported in the flow path 110 (replenishment flow path) must be degassed. In this case, the vacuum pump 113 may be operated for a given time period so that the ink transported in the second passage 150 is degassed by the degassing module 151. In this case, it is desirable that the controller 201a should cause the degassing module 151 to perform the degassing process before starting the removal of the recording head 51 (couplings 52a and 52b). Consequently, degassing of the ink is performed before replacement of the recording head 51, thereby preventing bubbles from entering the second intermediate tank 60.

It is also desirable that the controller 201a should cause the degassing module 151 to start the degassing process after replacement of a recording head 51 and before opening the head rear electromagnetic valve 44 located downstream of the recording head 51.

Furthermore, when a component other than a recording head 51 in the flow path 120 (supply flow path) or the flow path 130 (collection flow path) is replaced between the first intermediate tank 30 and the degassing module 151 in the second passage 150, the above ink replacement sequence can be applied.

### 2. Second Embodiment

The second embodiment is an example that the first passage 140 and second passage 150 of the flow path 130 (collection flow path) in the first embodiment are integrated into one passage.

### [Ink Supply System of the Ink-Jet Recording Device]

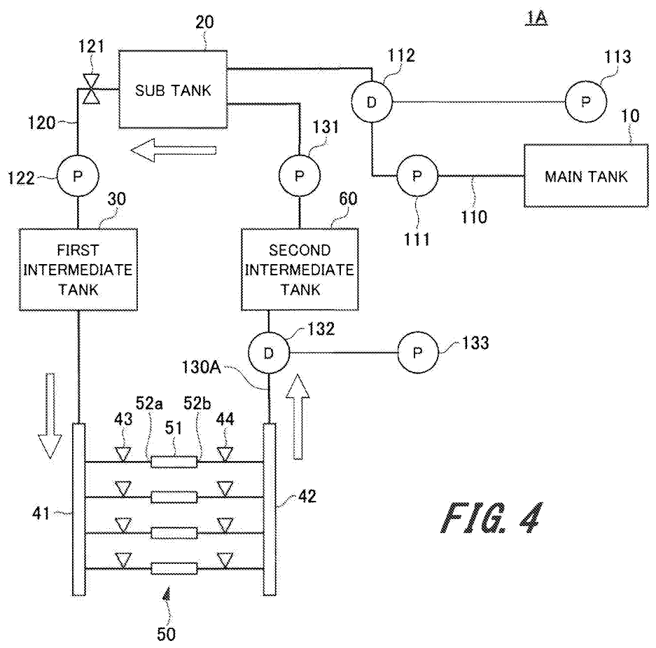

FIG. 4 shows an example of the configuration of the ink supply system of the ink-jet recording device according to the second embodiment. The ink-jet recording device 1A shown in FIG. 4 is structured so that the collection side manifold 42 of the head unit 50 and the second intermediate tank 60 are connected by one flow path 130A (an example of the collection flow path). A degassing module 132 is provided midway in the flow path 130A. The degassing module 132 may be the same as the degassing module 151 shown in FIG. 1.

The degassing module 132 (second degassing module) performs the degassing process to remove bubbles and dissolved gas from the ink transported from the head unit 50 to the second intermediate tank 60. The degassing module 132 collects the bubbles generated in the ink and dissolved gas through a permeable membrane by operation of the vacuum pump 133 (second vacuum pump). In the present embodiment, since the vacuum pump 113 (first vacuum pump) connected to the degassing module 112 (first degassing module) is assumed to be operated constantly, another vacuum pump 133 is provided.

### [Control System of the Ink-Jet Recording Device]

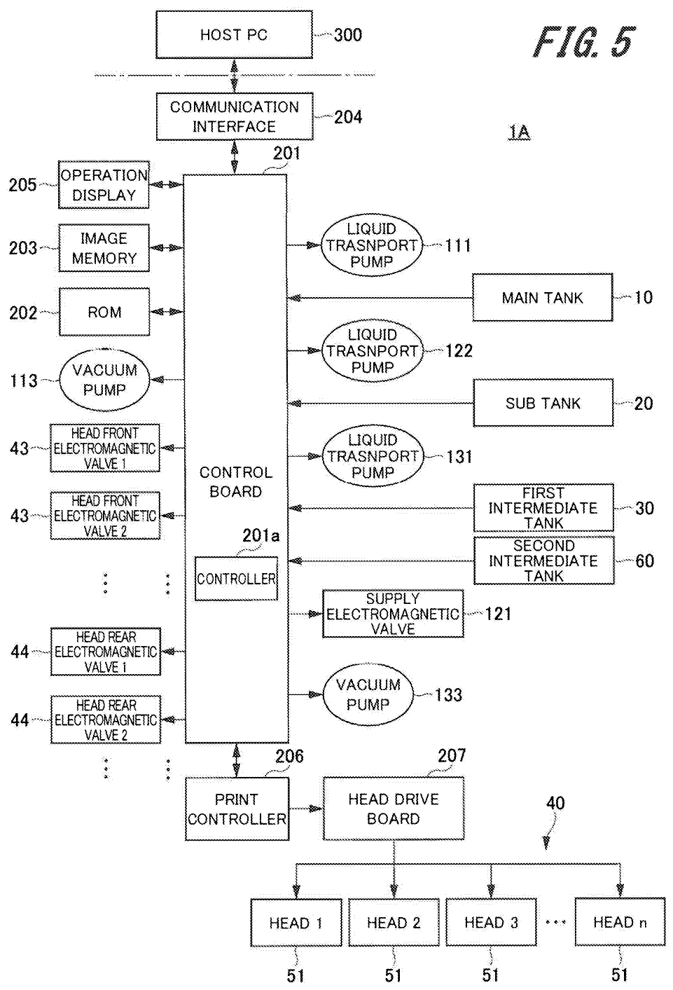

Next, the main part of the control system of the ink-jet recording device 1A will be described. FIG. 5 is a block diagram which shows an example of the configuration of the main part of the control system of the ink-jet recording device 1A. The ink-jet recording device 1A is different from the ink-jet recording device 1 in FIG. 2 in that the first electromagnetic valve 142 and second electromagnetic valve 152 are not provided and the vacuum pump 133 is provided.

### [Component Replacement Sequence]

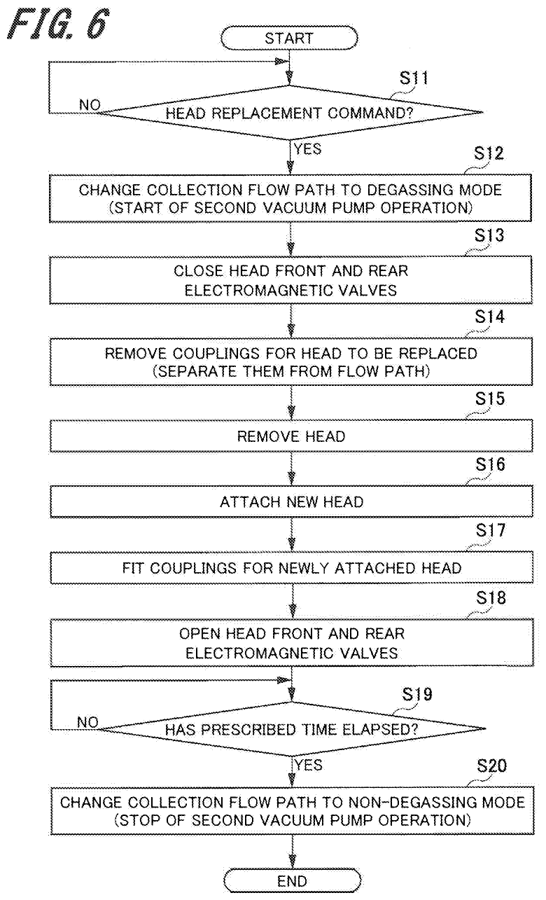

Next, an example of the component replacement sequence for the ink-jet recording device 1A will be explained. FIG. 6 is a flowchart which shows an example of the component replacement sequence.

It is assumed here that in the non-degassing mode, the controller 201a causes the vacuum pump 113 connected to the degassing module 112 to be operated constantly.

First, the controller 201a determines whether or not a head replacement command has been entered in the operation display 205 (S11) and if a head replacement command has not been entered (NO at S11), this determination step is repeated. This process is the same as the process of Step S1 in FIG. 3.

On the other hand, if a head replacement command has been entered (an example of the condition to perform the degassing process) (YES at S11), in preparation for replacement of a recording head 51 the controller 201a changes the mode of the flow path 130A (collection flow path) to the degassing mode (S12). Specifically, the controller 201a starts operation of the vacuum pump 133 (second vacuum pump) connected to the degassing module 132 located in the collection flow path and starts the degassing process by the degassing module 132 (second degassing module).

Next, the controller 201a performs control to stop operation of various parts related to ink supply (for example, liquid transport pumps) and close the head front electromagnetic valve 43 and head rear electromagnetic valve 44 relating to the recording head 51 to be replaced (S13). This process is the same as Step S2 in FIG. 3.

Next, the worker removes the couplings 52a and 52b for the recording head 51 to be replaced and separates the recording head 51 from the unit inside flow path (S14). Then, the worker removes the recording head 51 from the head unit 50 (S15). Then, the worker attaches a new recording head 51 to the head unit 50 (S16) and fits the couplings 52a and 52b for the newly attached recording head 51 and connects the recording head 51 to the unit inside flow path (S17). These steps are the same as Steps S3 to S6 in FIG. 1.

Next, the controller 201a performs control to open the head front electromagnetic valve 43 and head rear electromagnetic valve 44 which are in the closed state (S18). Then, the controller 201a determines whether or not a prescribed time has elapsed since the head front electromagnetic valve 43 and head rear electromagnetic valve 44 have been opened (S19), and if the prescribed time has not elapsed (NO at S19), this determination step is repeated.

On the other hand, if the prescribed time has elapsed (YES at S19), the controller 201a stops operation of the vacuum pump 133 and returns the mode of the flow path 130A (collection flow path) to the non-degassing mode (S20).

Next, the controller 201a activates various parts related to ink supply (for example, liquid transport pumps) according to the demand of the head unit 50 for ink. The controller 201a ends the sequence shown in the flowchart of FIG. 6 after the process of Step S20 is ended.

According to the above second embodiment, when a recording head 51 is replaced, the controller 201a changes the mode of the flow path 130A (collection flow path) to the degassing mode (turns on the vacuum pump 133) so that the ink discharged from the recording head 51 is degassed and brought into the second intermediate tank 60. Consequently, the ink which is discharged from the recording head 51 and brought into the second intermediate tank 60 is degassed by the degassing module 132, thereby preventing bubbles from entering the second intermediate tank 60.

Furthermore, according to the second embodiment, in order to degass the ink, the vacuum pump 133 is operated to change the mode of the flow path 130A to the degassing mode to degas the ink discharged from the recording head 51 by the degassing module 132, so degassing is done only when necessary. Consequently, the ink degassing time can be minimized and the deterioration of ink (increase in viscosity) can be suppressed.

Furthermore, also in the second embodiment, as for a plurality of recording heads 51 arranged in the head unit 50, each recording head 51 can be replaced individually as in the first embodiment, so the object of degassing is the ink in the flow path connected to the recording head 51 to be replaced.

Furthermore, in the second embodiment, switching to the degassing mode is made immediately after entry of a head replacement command and the degassing process is started; however, the time to start the degassing process can be varied as in the first embodiment. For example, the time to start the degassing process may be set so that degassing is started before the removal of a recording head 51 (couplings 52a and 52b) is started, or after replacement of a recording head 51 and before the head rear electromagnetic valve 44 located downstream of the recording head 51 is closed.

Furthermore, when a component other than a recording head 51 in the flow path 120 (supply flow path) or the flow path 130A is replaced between the first intermediate tank 30 and the degassing module 132 in the flow path 130A (collection flow path), the above ink replacement sequence can also be applied.

### 3. Modifications

In the above first and second embodiments, the ink supply system of the ink-jet recording device (1, 1A) includes the first intermediate tank 30 and second intermediate tank 60; however, the invention is not limited thereto. In other words, in order to supply ink to each recording head 51 of the head unit 50 adequately, it is desirable for the system to include the first intermediate tank 30 and second intermediate tank 60, but the first intermediate tank 30 and second intermediate tank 60 are not essential. For example, the system may only include the second intermediate tank 60 as an intermediate tank. In this case, operation of each liquid transport pump is controlled not according to the internal pressure difference between the first intermediate tank 30 and second intermediate tank 60 but according to the liquid level or internal pressure of the second intermediate tank 60. In addition, the main tank 10 and sub tank 20 may be integrated into one common tank.

Furthermore, in the above first and second embodiments, the degassing modules 151 and 132 in the collection flow path may be located downstream of the second intermediate tank 60 and upstream of the sub tank 20.

In the above first and second embodiments, the system may be structured so that when the ink-jet recording device is turned on after the ink-jet recording device has been unused for a long time (an example of the condition to perform the degassing process), the mode of the collection flow path is changed to the degassing mode. If the ink-jet recording device has been unused for a long time, the dissolved gas in the ink remaining in the flow path or tank may turn into bubbles. Therefore, by switching to the degassing mode to degas the ink at the moment the power is turned on after the device has been unused for a long time, bubble-free ink can be supplied to the recording heads 51 throughout the circulation passage (collection flow path and supply flow path).

The present invention is not limited to the above embodiments, but obviously the invention may be embodied and applied in other various ways without departing from the gist of the present invention as described in the appended claims.

For example, the above embodiments have been described in detail for easy understanding of the present invention; however, the present invention is not limited to a structure which includes all the elements described above. An element of an embodiment may be replaced by an element of another embodiment. An element of an embodiment may be added to another embodiment. For an element of each embodiment, addition, deletion or replacement of another element can be made.

The above elements, functions, processors and so on may be, in part or in whole, implemented by hardware, for example, as integrated circuitry. Also, the above elements, functions and so on may be implemented by software so that a processor interprets and executes the program to perform the functions. The information such as programs, tables and files to perform the functions may be placed in a recording device such as a memory, a hard disk or an SSD (Solid State Drive) or in a recording medium such as an IC card, a SD card or a DVD.

Although embodiments of the present invention have been described and illustrated in detail, the disclosed embodiments are made for purposes of illustration and example only and not limitation. The scope of the present invention should be interpreted by terms of the appended claims.

### REFERENCE SIGNS LIST

10 . . . main tank,
20 . . . sub tank (ink supply tank),
30 . . . first intermediate tank,
40 . . . supply side manifold,
50 . . . head unit,
51 . . . head,
52a, 52b . . . coupling,
60 . . . second intermediate tank,
110 . . . flow path,
113 . . . vacuum pump,
120 . . . flow path (supply flow path),
130 . . . flow path (collection flow path),
132 . . . degassing module,
133 . . . vacuum pump,
140 . . . first passage.
142 . . . first electromagnetic valve,
150 . . . second passage,
151 . . . degassing module,
152 . . . second electromagnetic valve,
201a . . . controller

What is claimed is:

1. An ink-jet recording device comprising:
a tank which stores ink;
a recording head to which the ink in the tank is supplied;
a supply flow path for allowing the ink in the tank to flow to the recording head;
a collection flow path for returning the ink discharged from the recording head to the tank; and
a degassing module which is located downstream of the recording head and upstream of the tank in the collection flow path and when a condition to perform a degassing process to remove bubbles contained in the ink discharged from the recording head is satisfied, performs the degassing process.

2. The ink-jet recording device according to claim 1, further comprising:
a controller which, when the condition to perform the degassing process is satisfied, changes a mode of the collection flow path from a non-degassing mode in which the degassing module does not perform the degassing process, to a degassing mode in which the degassing module performs the degassing process.

3. The ink-jet recording device according to claim 2,
the collection flow path comprising:
a first passage in which the ink discharged from the recording head is brought into the tank without being passed through the degassing module in the non-degassing mode;
a first on-off valve located midway in the first passage;
a second passage in which the ink discharged from the recording head is brought into the tank through the degassing module in the degassing mode; and
a second on-off valve located midway in the second passage and downstream of the degassing module, wherein
when a component provided on the supply flow path or on the collection flow path between the tank and the degassing module is replaced, the controller sets the first on-off valve to a closed state and sets the second on-off valve to an open state to change the mode of the collection flow path to the degassing mode and brings the ink discharged from the recording head into the tank through the second passage of the collection flow path.

4. The ink-jet recording device according to claim 3, wherein the component is the recording head.

5. The ink-jet recording device according to claim 3, wherein the controller causes the degassing module to perform the degassing process before removal of the component is started.

6. The ink-jet recording device according to claim 5, wherein
the collection flow path includes an on-off valve located downstream of the recording head and upstream of a branching point between the first passage and the second passage, and
the controller causes the degassing module to perform the degassing process before the on-off valve is opened after replacement of the recording head.

7. The ink-jet recording device according to claim 4, wherein, after a worker completes replacement of the recording head and after the degassing module performs the degassing process for a prescribed time period in the degassing mode, the controller switches to the non-degassing mode.

8. The ink-jet recording device according to claim 1, wherein the degassing module is connected to a vacuum pump for collecting bubbles generated in the ink.

9. The ink-jet recording device according to claim 1,
the tank comprising:
an ink supply tank located upstream of the recording head to store the ink to be supplied to the recording head; and
an intermediate tank located between the degassing module in the collection flow path and the ink supply tank to store the ink which is discharged from the recording head and returned to the ink supply tank.

10. The ink-jet recording device according to claim 3,
the tank comprising:
an ink supply tank located upstream of the recording head to store the ink to be supplied to the recording head; and
an intermediate tank located between the degassing module in the collection flow path and the ink supply tank to store the ink which is discharged from the recording head and returned to the ink supply tank, wherein
the first passage connects the recording head and the intermediate tank, and
the second passage connects the recording head and the intermediate tank through the degassing module.

11. An ink transport method for an ink-jet recording device comprising a tank which stores ink, a recording head to which the ink in the tank is supplied, a supply flow path for allowing the ink in the tank to flow to the recording head, and a collection flow path for returning the ink discharged from the recording head to the tank, wherein
the ink-jet recording device includes a degassing module located downstream of the recording head and upstream of the tank in the collection flow path, and
when a condition to perform a degassing process to remove bubbles contained in the ink discharged from the recording head is satisfied, the degassing module performs the degassing process.
